(19) United States
(12) Patent Application Publication
(10) Pub. No.: US 2009/0055301 A1
(43) Pub. Date: Feb. 26, 2009

(54) COMPUTER-BASED FINANCIAL BOND MANAGEMENT SYSTEM

(76) Inventor: Patrick Michael Drury, Lancashire (GB)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/191,384

(22) Filed: Aug. 14, 2008

(30) Foreign Application Priority Data
Aug. 21, 2007 (GB) 0716297.7

(51) Int. Cl. G06Q 40/00

(52) U.S. Cl. 705/35

(57) ABSTRACT

An apparatus comprising a controller arranged to generate options for division of a prize fund, to send the options to a plurality of remote terminals, to receive from the plurality of remote terminals voting signals each corresponding to one of the options and to divide the prize fund into one or more prizes based on the options receiving the most votes, to thereby create a dynamic and flexible financial bond management system.

This application claims priority to United Kingdom Application No. GB0716297.7 filed on Aug. 21, 2007.

### BACKGROUND OF THE INVENTION

The invention relates generally to the field of computer-based financial management systems. In particular, the invention relates to a financial management system and method in which (a) bonds are purchased by bondholders, (b) a prize fund is generated using the capital received in exchange for the bonds, and (c) the prize fund is allocated to one or more selected bondholders on a regular prize draw date.

In the United Kingdom, a known financial bond system exists in which interest payments are accumulated into a common prize fund which is subsequently allocated to one or more bondholders every month. This financial bond system has been around for many decades and is called “Premium Bonds”. The system is administered by National Savings & Investment.

Premium Bonds pay out a predetermined number of higher value, medium value and lower value prizes each month. The number of medium and lower value prizes is determined according to the amount of interest generated by the prize fund. A predefined formula is used to determine the precise number of prizes. Currently, prize values range from 535 1,000,000 down to £50.

The Premium Bond system is very successful and popular, having over 23 million bondholders and a common fund value of over £26 billion. See http://www.nsandi.com for more information. Whilst successful, the Premium Bond system is inflexible.

### BRIEF SUMMARY OF THE INVENTION

The invention aims to address the aforesaid problem by providing a more flexible computer-based financial bond system.

In particular, an aim of the invention is to provide a computer-based financial bond management system in which allocation of the prize fund is dynamic.

According to the present invention there is provided an apparatus and method as set forth in the appended claims. Other features of the invention will be apparent from the dependent claims, and the description which follows.

According to one aspect of the invention, there is provided a computer-based financial bond management system comprising an interface having one or more communications ports; a registration module arranged to create a user account in response to a request received via the one or more communications ports, and to create further user accounts in response to further requests received via the one or more communications ports; a data storage module arranged to store data relating to each user account created; a bond issuing module arranged to receive a bond issue request signal corresponding to a user account and to generate a unique bond ID corresponding to the user account, and to repeat when further request signals are received; a user preference module arranged to generate options for dividing a prize fund, to send the options to a plurality of user accounts and to receive from the plurality of user accounts voting signals each corresponding to one of the options; a prize fund calculation module arranged to determine a final prize fund for a respective prize draw; and a prize fund allocation module arranged to divide the final prize fund into one or more prizes based on the option receiving the most voting signals, and to match the or each prize to a corresponding unique bond ID selected at random, so that, in use, one or more corresponding user accounts are credited with one or more prizes divided from the final prize fund.

In this way, a dynamic and flexible system is achieved wherein each user account influences the final allocation of the prize fund. One large prize or several or multitudes of smaller value prizes may be chosen by the participants. The inventor anticipates that this will increase the number of users to thereby increase revenue generated and to increase savings rates among the public.

In the exemplary embodiment, the user preference module is arranged to send options only to user accounts that correspond to at least one unique bond ID.

In the exemplary embodiment, the vote received from a user account corresponding to more than one unique bond ID is weighted in proportion to the number of unique bond IDs to which the user account corresponds.

In the exemplary embodiment, the user preference module sends one or more of a current prize fund, a projected prize fund and a number of unique bond IDs currently in existence with the options for division of a prize fund.

In the exemplary embodiment, each user account has a unique login ID and password, and each vote is only received when the login ID and password have been verified.

In the exemplary embodiment, the prize fund calculation module is further arranged to output a current prize fund for a respective draw via the one or more communication ports. The prize fund calculation module may be further arranged to output a projected prize fund for a respective draw via the one or more communication ports. The prize fund calculation module may be arranged to output the number of unique bond IDs corresponding to user accounts.

In the exemplary embodiment, the system further comprises a bond purchase module arranged to request payment in response to a bond issue request signal, and once payment has been received to output a payment verification signal. Optionally, the bond issuing module is arranged to generate the unique bond ID only once the payment verification signal has been received from the bond purchase module, to allocate a bond initiation date to the unique bond ID based on the date the payment verification signal has been received, and to calculate a minimum duration period for the unique bond ID based on the initiation date.

In the exemplary embodiment, the system further comprises a bond refund module arranged to receive a redeem signal from a user account in respect of a unique bond ID, and to remove unique bond ID from the user account and to redeem the purchase price of the unique bond ID only once the minimum duration period has expired. Optionally, the bond refund module is arranged to output bond expiry data to a user account when the minimum duration period has expired and to present the user account with the option to request redemption of the unique bond ID or the option to purchase further new unique bond IDs.

In the exemplary embodiment, the predetermined minimum duration is 12 months or 12 draws. Also, the generated unique bond ID may be immediately eligible for a next draw.

In the exemplary embodiment, at least one of the communication ports is connected to a computer network for communication with a remote terminal, so that a user can access the system remotely to register, login, purchase a unique bond ID and select an option for dividing the prize fund.

In the exemplary embodiment, the system further comprises a notification module arranged to notify each holder of a user account corresponding to a selected unique bond ID that a prize has been won, and to pay the prize to the holder using payment details stored in the corresponding user account.

In the exemplary embodiment, each issued unique bond ID costs a user account a predetermined amount of money and the prize fund is based at least partly on a predetermined interest rate accrued in respect of the money received for each issued bond ID.

According to another aspect of the invention, there is provided a method of managing a computer-based financial bond management system in which a prize fund is shared between one or more selected bondholders on at least one predetermined prize draw date, the method comprising providing an interface having one or more communications ports; creating a user account in response to a request received via the one or more communications ports, and creating further user accounts in response to further requests received via the one or more communications ports; storing data relating to each user account created; receiving a bond issue request signal corresponding to a user account, generating a unique bond ID corresponding to the user account, and repeating when further request signals are received; generating options for dividing a prize fund, sending those options to a plurality of user accounts and receiving from the plurality of user accounts voting signals each corresponding to one of the options; determining a final prize fund for a respective prize draw; and dividing the final prize fund into one or more prizes based on the option receiving the most voting signals, and matching the or each prize to a corresponding unique bond ID selected at random, so that, in use, one or more corresponding user accounts are credited with one or more prizes divided from the final prize fund.

According to yet another aspect of the invention, there is provided an apparatus comprising a controller arranged to generate options for division of a prize fund, to send the options to a plurality of remote terminals, to receive from the plurality of remote terminals voting signals each corresponding to one of the options and to divide the prize fund into one or more prizes based on the option receiving the most votes.

According to yet another aspect of the invention, there is provided a method comprising the steps of generating options for division of a prize fund; sending the options to a plurality of remote terminals; receiving from the plurality of remote terminals voting signals corresponding to one of the options; and dividing the prize fund into one or more prizes based on the option receiving the most votes.

### BRIEF DESCRIPTION OF THE DRAWINGS

FIG. 1 is a high-level schematic view of a computer-based financial bond management system according to an embodiment of the invention;

FIG. 2 is a more detailed schematic view of the computer-based financial bond management system of FIG. 1;

FIG. 3 is a schematic view illustrating an exemplary account management module of the system of FIG. 2;

FIG. 4 is a schematic view illustrating an exemplary data storage module of the system of FIG. 2;

FIG. 5 is a schematic view illustrating an exemplary bond issuing module of the system of FIG. 2;

FIG. 6 is a schematic view illustrating an exemplary user preference module of the system of FIG. 2;

FIG. 7 is a schematic view illustrating an exemplary prize fund allocation module of the system of FIG. 2;

FIG. 8 is a flow chart illustrating the main process steps taken by the system of FIG. 2;

FIG. 9 is a flow chart illustrating an exemplary user login/registration process;

FIG. 10 is a flow chart illustrating an exemplary bond purchase/issue process;

FIG. 11 is a flow chart illustrating an exemplary user preference request process;

FIG. 12 is a flow chart illustrating an exemplary prize fund allocation process;

FIG. 13 is a flow chart illustrating an exemplary prize payment process; and

FIG. 14 is a flow chart continuing the illustration of the prize payment process according to FIG. 13.

### DETAILED DESCRIPTION OF THE INVENTION

Reference will now be made in detail to an embodiment of the invention, examples of which are illustrated in the accompanying drawings, wherein like reference numerals refer to like elements throughout.

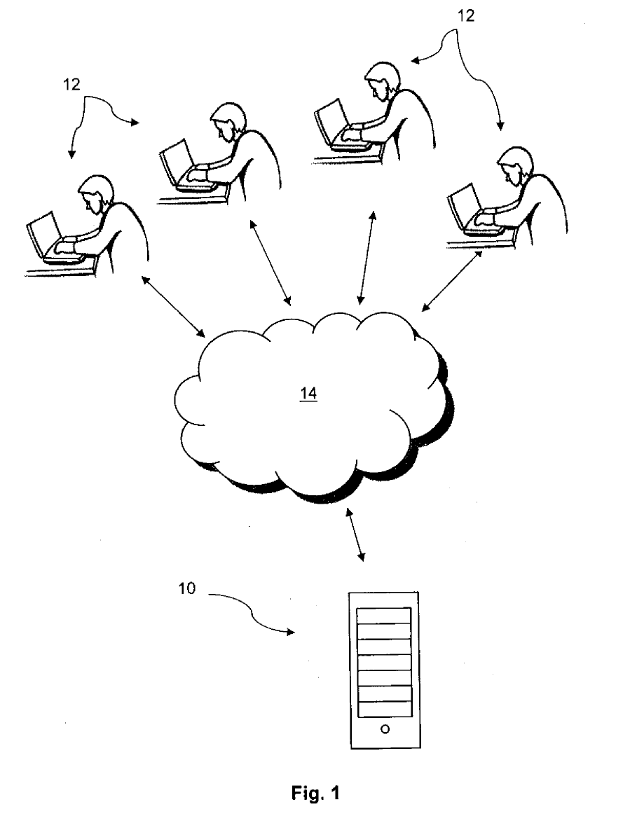

FIG. 1 is a high level schematic view showing the system 10 of an exemplary embodiment of the invention. The system 10 communicates with a number of remote terminals 12 over a computer network 14 which, in the exemplary embodiment, is the Internet. The system 10 is a web server which provides information using an extensible markup language (XML) such as hypertext markup language (HTML) and/or wireless markup language (WML) or any other suitable language used for providing information over the Internet. Communication between the system 10 and the remote terminals 12 is handled using the well-known TCP/IP protocol suite.

In the exemplary embodiment, the remote terminals 12 are personal computers, mobile telephones, personal digital assistants (PDAs) or the like which run web browsing software suitable for accessing internet pages such as HTML or WML pages.

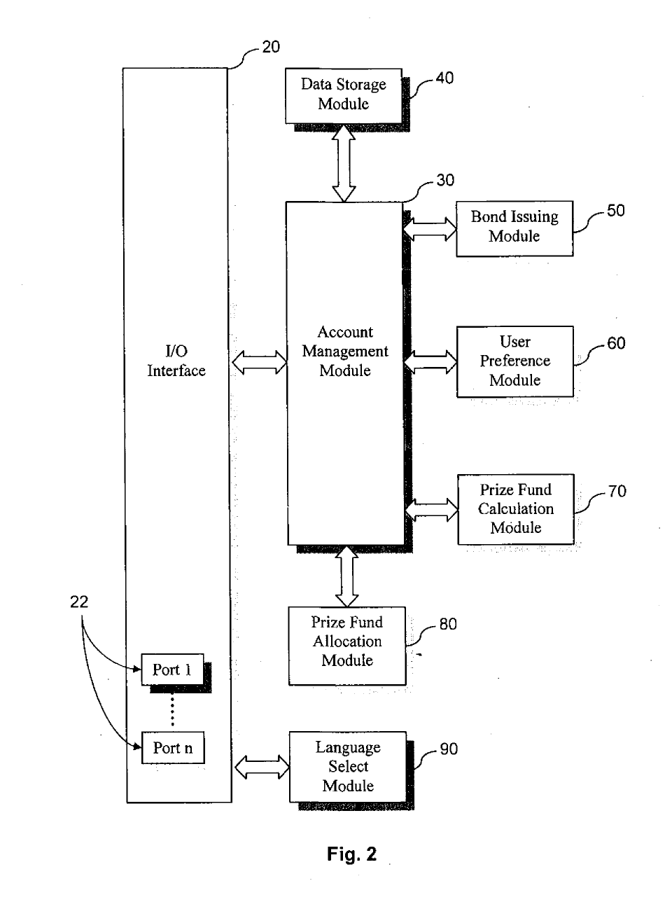

FIG. 2 shows the financial bond management system 10 of FIG. 1 in more detail.

The system 10 comprises an I/O interface 20, an account management module 30, a data storage module 40, a bond issuing module 50, a user preference module 60, a prize draw calculation module 70, a prize fund allocation module 80 and a language select module 90.

The I/O interface 20 has a plurality of communication ports (port 1 to port n) configured to establish client/server communication links between the remote terminals 12 and the system 10 over the network 14.

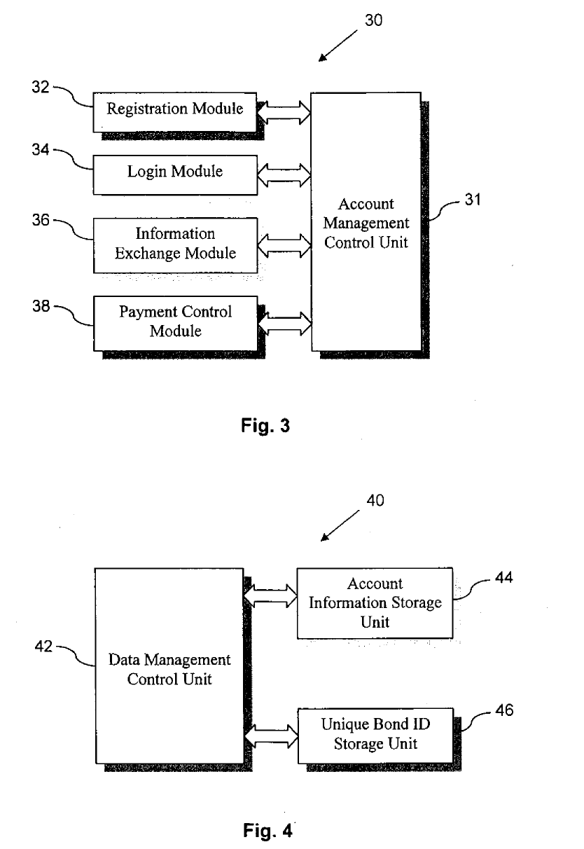

The account management module 30, data storage module 40, bond issuing module 50, user preference module 60 and prize fund allocation module 80 are described in more detail with reference to FIGS. 3 to 7.

FIG. 3 is a schematic view of the account management module 30.

The account management module 30 comprises an account management control unit 31, a login module 32, a registration module 34, an information exchange module 36 and a payment control module 38.

The account management control unit 31 is an application server arranged to provide login fields so that existing users are able to login to the system 10. The login fields are user ID and password. The account management control unit 31 also provides a registration option for new users not holding an account.

The login module 32 is arranged to process each login request made by a remote terminal 12 by matching a user ID and password to a user account. Upon receipt of a valid login request, the login module 32 allows the remote terminal 12 to access the respective user account via the account management control unit 31.

The registration module 34 is arranged to create new user accounts in response to requests for registration received from new users via the remote terminals 12. The registration module prompts each respective remote terminal 12 for various pieces of data relating to the user account. Once the mandatory fields are completed, the account management control unit 31 creates and stores a new user account in the data storage module 40.

The account management unit 31 outputs a bond purchase option to the respective remote terminal 12 upon successful registration or upon login. When the bond purchase option is selected, the account management unit 31 outputs a bond issue request.

The account management module 30 also has an information exchange module 32 which is arranged to relay data to/from the remote terminals 12.

The payment control module 38 is arranged to access third party payment portals to receive and verify payments. The payment control module 38 is also arranged to be able to transfer money to account holders via a third party payment module.

FIG. 4 is a schematic view of the data storage module 40.

The data storage module 40 comprises a data management control unit 42, an account information storage unit 44 and a unique bond ID storage unit 46.

The data management control unit 42 is arranged to receive account information on created accounts from the account management module 30 and to store the account information in the account information storage unit 44. The data management control unit 42 is also arranged to receive data relating to a unique bond ID and to store the data relating to the unique bond ID in the unique bond ID storage unit 46.

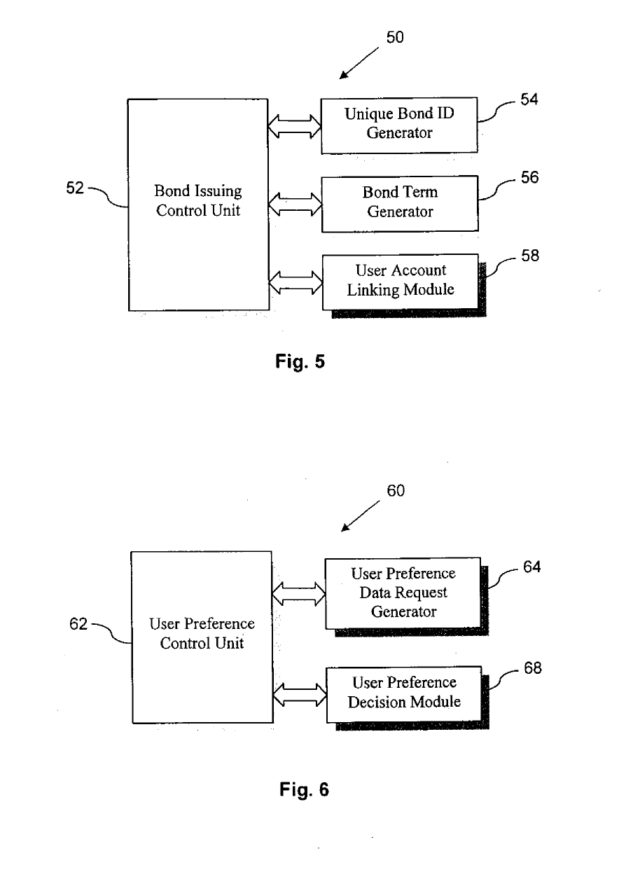

FIG. 5 is a schematic view of the bond issuing module 50.

The bond issuing module comprises a bond issuing control unit 52, a unique bond ID generator 54, a bond term generator 56 and a user account linking module 58.

The bond issuing control unit 52 is arranged to receive the bond issue request signal corresponding to a user account, and to generate a corresponding request for a unique bond ID.

The unique bond ID generator 54 is arranged to receive the request for a unique bond ID and to generate and return a unique bond ID. In the exemplary embodiment, each unique bond ID is generated by sequentially issuing numbers in a predetermined format. For example, in the exemplary embodiment, the first unique bond ID generated is 0000000001, and the second is 0000000002, and so on.

The bond term generator 56 is arranged to calculate and return the minimum duration of the unique bond ID based on the date that payment verification was received for the relevant unique bond ID.

The user account linking module 58 is arranged to communicate with the data storage module 40 to store the unique bond ID in the unique bond ID storage unit 48, to link the unique bond ID to the corresponding user account and to store the minimum bond duration for that unique bond ID in the respective user account.

FIG. 6 is a schematic view of the user preference module 60.

The user preference module 60 comprises a user preference control unit 62, a user preference data request generator 64 and a user preference decision module 66.

The user preference control unit 62 is arranged to coordinate user preference data requests and to collate responses at a predetermined time before a prize draw takes place. Firstly, the user preference control unit 62 is arranged to generate a request for user preference options. Secondly, once generated, the user preference control unit is arranged to send the user preference options by email to registered users having an account linked to at least one unique bond ID. Thirdly, the user preference control unit 62 is arranged to receive and process responses to the email.

In more detail, the user preference data request generator 64 is arranged to generate a list of prize draw options. The options are generated by the user preference data request generator 64 and, in the exemplary embodiment change from prize draw to prize draw. However, the options may remain the same from one prize draw to another.

An example of a list of prize draw options is given below, comprising five options.

The first option is to allocate the prize draw to one selected unique bond ID

The second option is to divide the prize fund between 5 selected unique bond IDs.

The third option is to divide the prize fund between 10 selected unique bond IDs.

The fourth option is to divide the prize fund between 15 selected unique bond IDs.

The fifth option is to divide the prize fund between 20 selected unique bond IDs.

Of course, different options may be generated allocating the prize fund differently. A larger split is possible as is uneven allocation of the prize fund into high and low prizes.

The user preference control unit 62 is arranged to receive the chosen option from each user who has replied, and to forward that option to the user preference decision module 66, together with data regarding the number of bonds held by each respective user account.

The user preference decision module 66 is arranged to interpret the chosen options in the user preference data collector 64 and determines how the prize fund will be allocated based on the option receiving the largest selection. Prize fund allocation data is then outputted. Further, in determining the prize fund allocation, each user account will have allocated one vote for each bond held. In other words, users holding many bonds will have more say than users holding just a few bonds. In the exemplary embodiment, a default preference is used unless a predetermined number of responses corresponding to 20 per cent of the total number of bonds currently active has been received before a predetermined cut-off date.

Also, in the exemplary embodiment, the user preference request is only activated after a predetermined number of user accounts have been generated, in this case 1,000,000. When this total is reached, the information exchange module 36 releases live statistics on the current prize fund. This is achieved by a mathematics module (not shown) which dynamically accesses the current interest rate and the number of issued bonds. Additionally, information regarding the prize fund allocation is also made available. This information may be dynamic, showing the projected prize fund allocation based on responses received prior to the cut-off date.

Referring back to FIG. 1, the prize fund calculation module 70 is arranged to calculate the final prize fund before a prize draw takes place. Again, this is achieved by calculating the total interest payable on the prize fund since the previous draw or since the inception of the system 10.

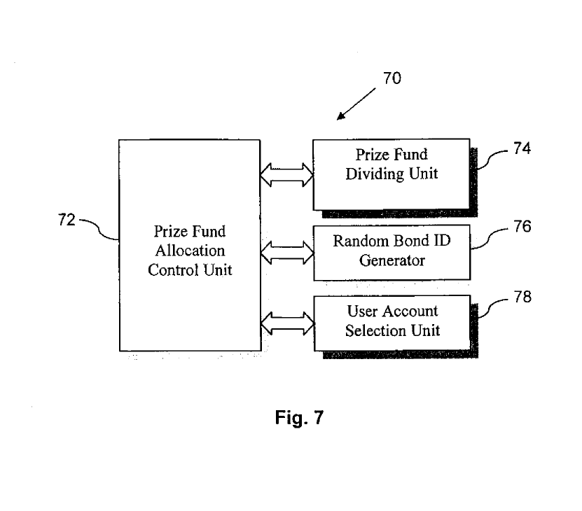

FIG. 7 shows a more detailed schematic view of the prize fund allocation module 80.

The prize fund allocation module 80 comprises a prize fund allocation control unit 82, a prize fund dividing unit 84, a random bond ID generator 86 and a user account selection unit 88.

The prize fund allocation control unit 82 is arranged to receive the final prize fund from the prize draw fund calculation module 70 and to receive the prize fund allocation data from the user preference decision module 66.

The final prize fund and the prize fund allocation data is passed to the prize fund dividing unit 84 which calculates the precise allocation of prizes and returns this data to the prize fund allocation control unit 82.

The prize fund allocation control unit 82 is arranged to request a number of bond IDs from the random bond ID generator 86 matching the number of prized to be allocated. The prize fund allocation control unit 80 is arranged to match each bond ID generated to a unique bond ID number held in the unique bond ID storage unit 46. The largest value or first prize is allocated to the first generated bond number, the next largest value or next prize to the next drawn bond number, and so on. The user account selection unit 88 is arranged to trace the link from each winning unique bond ID to the respective user account. In the exemplary embodiment, payment is then made to the account holder via the payment control module 38. It is envisaged that payment could be made via other third party means.

Finally, the language select module 90 is arranged to allow users to select their own preferred language.

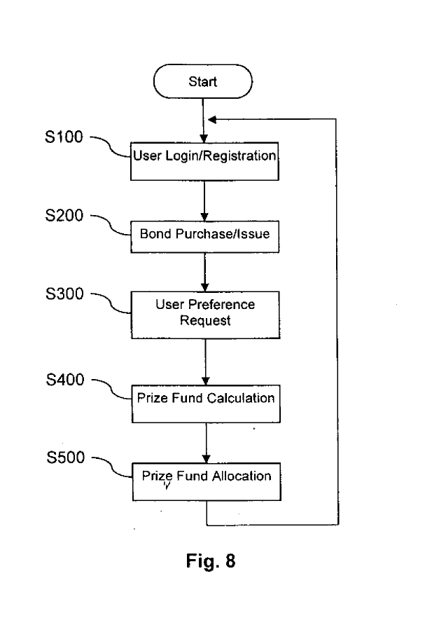

Operation of the system 10 is now described with reference to the flowcharts of FIGS. 8 to 14.

FIG. 8 is a flowchart showing a simplified overview of the system 10 according to the invention.

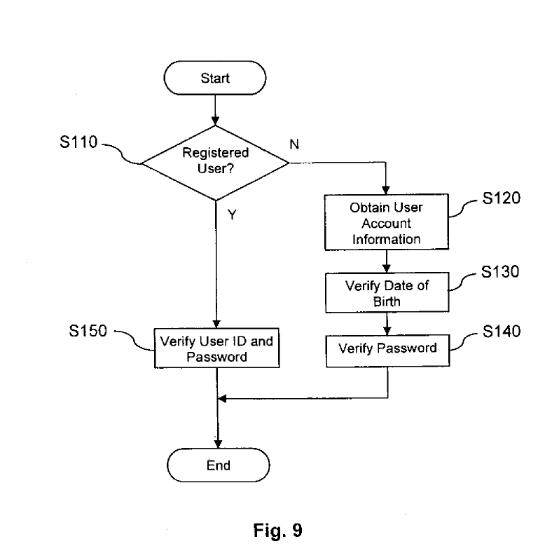

The system 10 comprises 5 basic steps. Step S100 concerns user login or registration. Step S200 concerns bond purchase and issue. Step S300 concerns user preference request and collation. Step S400 concerns prize fund calculation. Finally, step S500 concerns prize fund allocation. Each step is described in more detail below with reference to FIGS. 9 to 14

FIG. 9 shows the user login or registration step S100 in more detail. Firstly, a check is made as to whether a user is registered at step S110. In the exemplary embodiment, step S110 is implemented as a hyperlink which directs a user to a registration page. The registration page is represented at step S120.

In particular, the registration module 34 requests that the following fields are completed by each new user: name, postal address, e-mail address, date of birth, mobile telephone number and bond payment details. In the exemplary embodiment, name, e-mail address and date of birth are mandatory fields which must be completed before a new user account can be created. The name and date of birth are required to check the eligibility of the user to use the system 10. The email address is required to establish a unique user ID and to verify a communication path between the system 10 and the user.

At step S130, a check is made to ensure that the user account belongs to a person over a minimum age, in the exemplary embodiment 18 years old.

At step S140, a password is generated and sent to the user's e-mail account, along with a hyperlink to a verification page. Following the hyperlink verifies the account and logs the user into the system 10.

On completion of the verification process, the user account is created. The user's email address becomes the user ID and the user can logon to their account via the login module 34. The remaining details must be entered before a bond can be purchased.

At step S110 the user may not elect to follow the registration hyperlink and may instead enter a user ID and password to access their account.

At step S150, the user ID and password are checked with details of user accounts stored in the account information storage unit 44. If the user ID and password match an account, the account management module 30 allows the user to access their account information and update details.

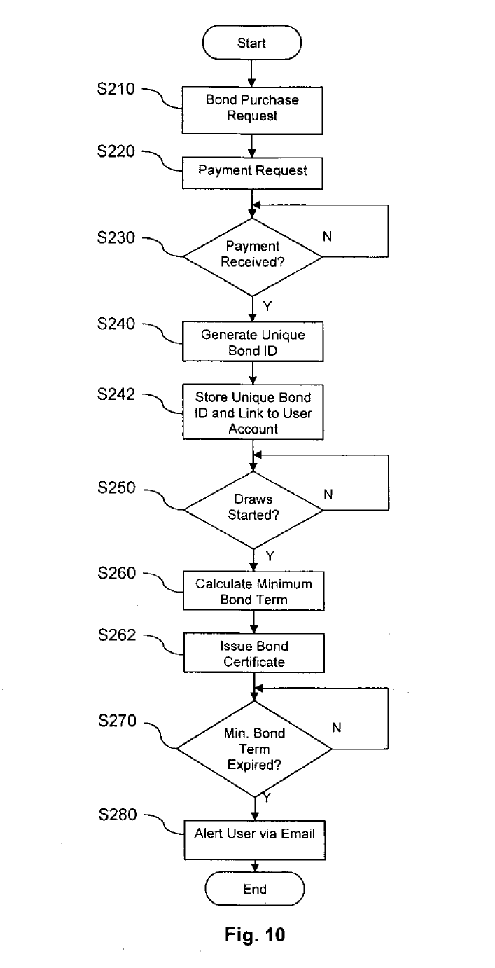

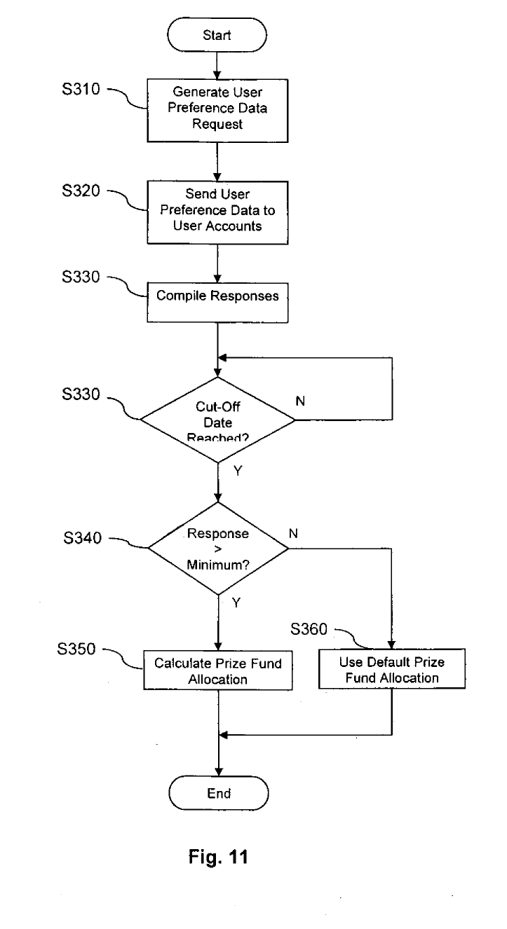

FIG. 10 shows the bond purchase/issue step S200 in more detail.

At step S210, a bond purchase option is generated by the account management module 30 once a user is registered and/or logged into the system 10. When the bond purchase option is selected, a bond payment request is generated and the payment control module 38 retrieves user payment information on the respective account from the account information storage unit 46. If no payment details are available for the account in question, then the account management module 30 requests account details. Confirmation that the account details are correct is then made, and the user has the option of updating the account details or confirming the bond purchase. In the exemplary embodiment a third party payment portal such as Paypal (a registered trade mark of Pay Pal, Inc.) is used.

Next, at step S220, a payment request is made using the payment control module 38. The payment control module returns a payment confirmation signal when the payment has been verified.

At step S230, a check is made as to whether payment has been received. If not, then the process waits. Eventually, if payment has not been received before a predetermined cut-off time limit, the bond purchase/issue request is cancelled. If the payment verification is received, then a bond issue request signal and the date payment was verified is sent to the bond issuing module 50.

At step S240, the bond issuing request signal is received by the bond issuing control unit 52. The unique bond ID generator 54 is then prompted to generate a unique bond ID based on previously issued unique bond IDs, and to return the unique bond ID to the bond issuing control unit 52.

At step S242, the bond issuing control unit 52 sends the generated unique bond ID to the unique bond ID storage unit 46, and requests that the data management control unit 42 creates a link between the account from which the bond purchase request issued and the unique bond ID stored in the unique bond ID storage unit 46.

At step S250, a check is made to see whether the system 10 is activated to commence prize draws. The system 10 is activated only when a predetermined number of unique bond IDs have been issued. In the exemplary embodiment, this figure is 1,000,000 but could be any other suitable figure. The bond purchase/issue step S200 is paused until the predetermined number is reached, wherein the process progresses to step S260.

At step S260, a minimum bond term is calculated for each unique bond ID generated by the bond term generator 56. If the draws have started, then the minimum bond term expiry date equals the date payment was verified plus 12 calendar months. If the draws had not started by the time payment verification was received, then the minimum bond term expiry date is 11 calendar months after the date the first draw is scheduled to take place.

At step S262, a bond certificate is issued when the minimum bond term has been calculated. The bond certificate is sent to the e-mail address associated with the respective user account. The bond certificate includes the name and e-mail address of the bondholder, the unique bond ID number and the minimum bond term expiry date.

At step S270, a check is made each day against all bonds stored in the unique bond ID storage unit 46. If bonds are located which have minimum bond term expiry dates on that day, an e-mail is sent to the e-mail address of the linked user account. The user is given an option to redeem the bond or to allow the bond to remain in the draw, after which the bond may be redeemed at any future time. The default setting is for the bond to remain in the draw.

FIG. 11 illustrates the user preference request step S300 in more detail.

At step S310, the user preference control unit 62 requests the user preference data request generator 64 to generate several prize draw allocation options from which users having an account linked to at least one unique bond ID can choose as discussed above.

At step S320, the prize draw allocation options are sent to the registered e-mail address of each account linked to at lest one unique bond ID. In the exemplary embodiment, the prize draw allocation options are sent as part of a monthly newsletter.

At step S330, the user preference control unit 62 receives responses from each user who has chosen to respond. The responses are weighted according to the number of unique bond IDs linked to the respective account.

Responses are compiled when a predetermined cut-off date is reached at step S340. In the exemplary embodiment, the cut-off date is the date of the draw.

At step S350, a check is made to determine whether a predetermined minimum response level has been reached. If responses, after weighting has been applied, correspond to less than 20% of the unique bond IDs, then a default prize fund allocation is used (step S360). If, on the other hand, the response is at least 20%, then the user preferences are used to determine the prize fund allocation (step S370). In the exemplary embodiment, the option receiving the most votes is used, taking into account weighting as mentioned above.

Referring again to FIG. 8, step S400 is not shown in further detail in the drawings. In step S400, the prize fund calculation module 70 determines the interest generated on the money received for purchased bonds, less expenses, for the period until the first draw, or the period between draws. In the exemplary embodiment, half of the interest is directed to the prize fund while half of the interest is taken as expenses. The prize fund calculation module 70 outputs the available prize fund.

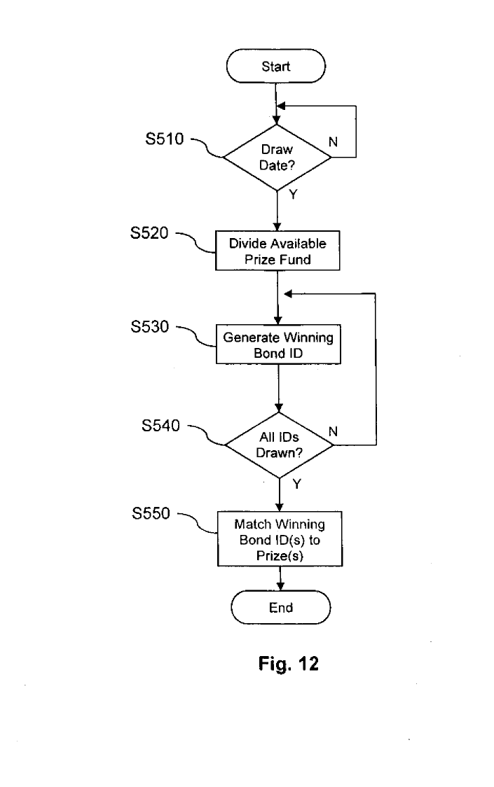

Step S500 is shown in more detail in FIG. 12.

At step S510, the prize fund allocation control unit 32 checks to determine if the draw date has arrived. If not, then the prize fund allocation module 80 waits. If the prize draw date has arrived, then the prize fund dividing unit 84 divides the available prize fund according to the user preference data at step S520. In this way, one large prize or several smaller prizes of similar or different values are generated.

At step S520, the prize fund allocation control unit 82 requests the random bond ID generator 86 to generate unique bond IDs at random to create winning unique bond IDs. The number of winning bond IDs corresponds to the number of prizes allocated. Only unique bond IDs which are currently linked to user accounts and which have not been redeemed are selected. In other words, a check is made to ensure a generated unique bond ID can lead to an entitled bondholder.

At step S540, a check is made to ensure that the number of issuing bond IDs matches the number of prizes. If not, a further issuing bond ID is generated, and so on.

At step S550, the user account selection unit 88 matches each winning bond ID with a user account using the link set up when the bond was purchased.

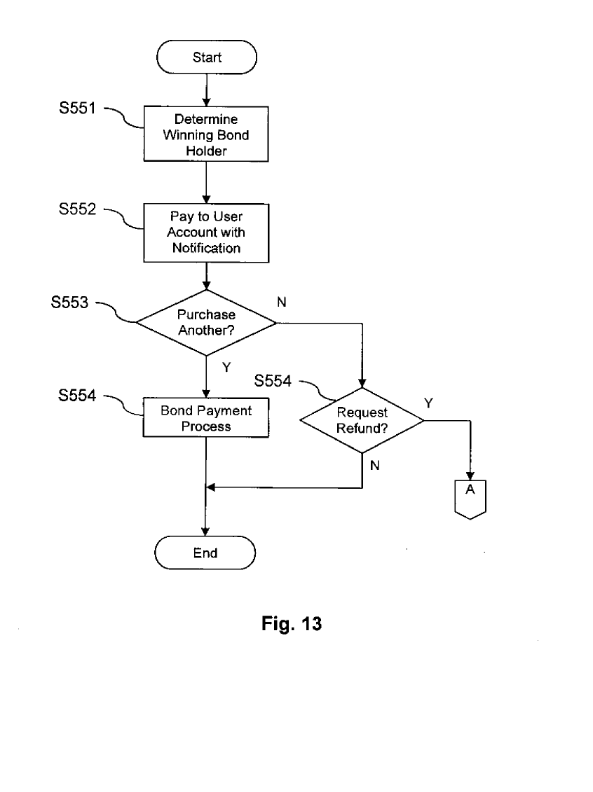

FIG. 13 illustrates step S550 in more detail.

At step S551, the winning bond holder is determined from the user account details matched to each winning bond ID. At step S552 a cash payout corresponding to the prize value is paid to the account holder. At the same time, the account holder is given the option to purchase further bonds.

At step S553, a check is made to determine whether or not the account holder does wish to purchase another bond. If so, the user is taken through the bond purchase/issue process as illustrated in FIG. 10.

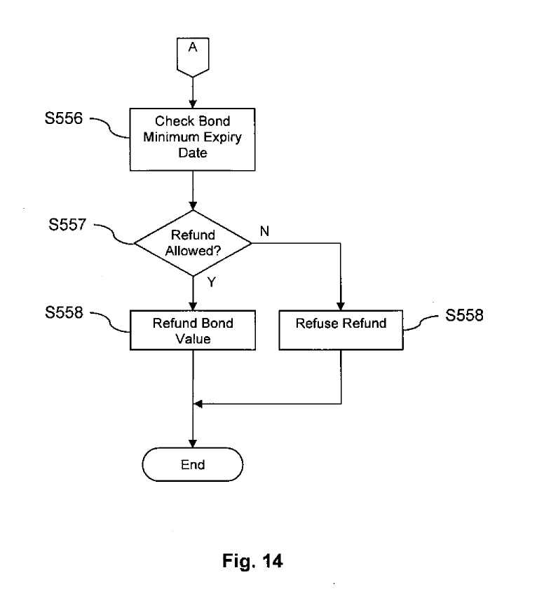

If not, a check is made as to whether or not the account holder wishes to request a refund at step S555. If not, then the process ends. If yes, then a refund procedure is outlined with reference to FIG. 14.

FIG. 14 outlines a bond refund request procedure.

At step S556, the minimum bond term is retrieved. At step S556, a check is made as to whether or not the minimum bond term has expired. If the minimum bond term has expired then the value of the bond is refunded to the account holder at step S558. If the minimum bond term has not expired, then the refund is refused at step S559.

The invention provides a system wherein each bondholder can influence the allocation of the prize fund. The system is therefore more flexible and dynamic than the prior art systems.

In the preferred embodiment, each prize draw occurs monthly. It is envisaged that other draw frequencies may be implemented, whether regularly or irregularly spaced apart. For example, it is envisaged that two draws could take place each month, or that bonus draws take place every quarter, or at random, to encourage more users to purchase bonds. Of course, fewer or more draws could take place, with for example draws only occurring when a predetermined number of bonds are sold. This could encourage users to buy more bonds or to recommend bond purchases to others.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer-based financial bond management system comprising:
an interface having one or more communications ports;
a registration module arranged to create a user account in response to a request received via the one or more communications ports, and to create further user accounts in response to further requests received via the one or more communications ports;
a data storage module arranged to store data relating to each user account created;
a bond issuing module arranged to receive a bond issue request signal corresponding to a user account and to generate a unique bond ID corresponding to the user account, and to generate further unique bond IDs when further request signals are received;
a user preference module arranged to generate options for dividing a prize fund, to send the options to a plurality of user accounts and to receive from the plurality of user accounts a plurality of voting signals each corresponding to one of the options;
a prize fund calculation module arranged to determine a final prize fund for a respective prize draw; and
a prize fund allocation module arranged to divide the final prize fund into one or more prizes based on the option receiving the most voting signals, and to match each prize of the one or more prizes to a corresponding unique bond ID selected at random, so that, in use, one or more corresponding user accounts are credited with one or more prizes divided from the final prize fund.

2. The system of claim 1, wherein the user preference module is arranged to send options only to user accounts that correspond to at least one unique bond ID.

3. The system of claim 2, wherein the voting signal received from a user account corresponding to more than one unique bond ID is weighted in proportion to the number of unique bond IDs to which the user account corresponds.

4. The system of claim 1, wherein the user preference module sends one or more of a current prize fund, a projected prize fund and a number of unique bond IDs currently in existence with the options for division of a prize fund.

5. The system of claim 1, wherein each user account has a unique login ID and password, and each vote is only received when the login ID and password have been verified.

6. The system of claim 1, wherein the prize fund calculation module is further arranged to output a current prize fund for a respective draw via the one or more communication ports.

7. The system of claim 1, wherein the prize fund calculation module is further arranged to output a projected prize fund for a respective draw via the one or more communication ports.

8. The system of claim 1, wherein the prize fund calculation module is arranged to output the number of unique bond IDs corresponding to user accounts.

9. The system of claim 1, the system further comprising a bond purchase module arranged to request payment in response to a bond issue request signal, and once payment has been received to output a payment verification signal.

10. The system of claim 9, wherein the bond issuing module is arranged to generate the unique bond ID only once the payment verification signal has been received from the bond purchase module, to allocate a bond initiation date to the unique bond ID based on the date the payment verification signal has been received, and to calculate a minimum duration period for the unique bond ID based on the initiation date.

11. The system of claim 10, the system further comprising a bond refund module arranged to receive a redeem signal from a user account in respect of a unique bond ID, and to remove unique bond ID from the user account and to redeem the purchase price of the unique bond ID only once the minimum duration period has expired.

12. The system of claim 11, wherein the bond refund module is arranged to output bond expiry data to a user account when the minimum duration period has expired and to present the user account with the option to request redemption of the unique bond ID or the option to purchase further new unique bond IDs.

13. The system of claim 10, wherein the predetermined minimum duration is 12 months or 12 draws.

14. The system of claim 10, wherein the generated unique bond ID is immediately eligible for a next draw.

15. The system of claim 1, wherein at least one of the communication ports is connected to a computer network for communication with a remote terminal, so that a user can access the system remotely to register, login, purchase a unique bond ID and select an option for dividing the prize fund.

16. The system of claim 1, the system further comprising a notification module arranged to notify each holder of a user account corresponding to a selected unique bond ID that a prize has been won, and to pay the prize to the holder using payment details stored in the corresponding user account.

17. The system of claim 1, wherein each issued unique bond ID costs a user account a predetermined amount of money and the prize fund is based at least partly on a predetermined interest rate accrued in respect of the money received for each issued bond ID.

18. A method of managing a computer-based financial bond management system in which a prize fund is shared between one or more selected bondholders on at least one predetermined prize draw date, the method comprising:
providing an interface having one or more communications ports;
creating a user account in response to a request received via the one or more communications ports, and creating further user accounts in response to further requests received via the one or more communications ports;
storing data relating to each user account created;
receiving a bond issue request signal corresponding to a user account, generating a unique bond ID corresponding to the user account, and repeating when further request signals are received;
generating options for dividing a prize fund, sending those options to a plurality of user accounts and receiving from the plurality of user accounts a plurality of voting signals each corresponding to one of the options;
determining a final prize fund for a respective prize draw; and
dividing the final prize fund into one or more prizes based on the option receiving the most voting signals, and matching each prize of the one or more prizes to a corresponding unique bond ID selected at random, so that, in use, one or more corresponding user accounts are credited with one or more prizes divided from the final prize fund.

19. An apparatus comprising:
a controller arranged to generate options for division of a prize fund, to send the options to a plurality of remote terminals, to receive from the plurality of remote terminals a plurality of voting signals each corresponding to one of the options, and to divide the prize fund into one or more prizes based on the option receiving the most voting signals.

20. A method comprising the steps of:
generating options for division of a prize fund;
sending the options to a plurality of remote terminals;
receiving from the plurality of remote terminals a plurality of voting signals each corresponding to one of the options; and
dividing the prize fund into one or more prizes based on the option receiving the most voting signals.
